(19) United States
(12) Patent Application Publication
(10) Pub. No.: US 2020/0088964 A1
(43) Pub. Date: Mar. 19, 2020

(54) MECHANICAL CABLE ENTRY PORT

(71) Applicant: Corning Research & Development Corporation, Corning, NY (US)

(72) Inventors: Christophe Desard, Herbignac (FR); Donald Kent Larson, Cedar Park, TX (US); Zachary Michael Thompson, Austin, TX (US); Gaetan Perrier, Austin, TX (US)

(21) Appl. No.: 16/694,560

(22) Filed: Nov. 25, 2019

Related U.S. Application Data
(63) Continuation of application No. PCT/US2018/031819, filed on May 9, 2018.
(60) Provisional application No. 62/510,001, filed on May 23, 2017.

(51) Int. Cl. G02B 6/44

(52) U.S. Cl. CPC G02B 6/4454

(57) ABSTRACT

An advanced port entry device for a telecommunication enclosure is described. The port entry device comprises a sealing body having an internal passageway extending from a first end of the sealing body to a second end of the sealing body that is configured to sealingly engage with a port of the telecommunication enclosure, wherein the sealing body has an internal, and a tray member extending from the first end of the sealing body wherein the tray member is configured to pass through the port so that it resides within the protected interior space of the telecommunication enclosure when the port entry device is installed.

### CROSS-REFERENCE TO RELATED APPLICATIONS

This application is a continuation of International Application No. PCT/US2018/031819, filed May 9, 2018 which claims the benefit of priority to U.S. Provisional Application Ser. No. 62/510,001 filed on May 23, 2017, the content of each priority application is relied upon and incorporated herein by reference in its entirety.

### FIELD OF THE INVENTION

The present invention relates to an advanced cable entry device useful for plug and play fiber to the home network expansions. In particular, this invention relates to an entry device having additional functionality beyond providing an environmental seal. The advanced entry device can be a cable management device, an optical component holding device, an optical fiber slack storage device, and/or optical fiber connectivity device which can be assembled outside of an optical fiber enclosure and plugged into the enclosure through a cable port of a telecommunication enclosure.

### BACKGROUND OF THE INVENTION

Telecommunication cables are ubiquitous and used for distributing all manner of data across vast networks. The majority of cables are electrically conductive cables (typically copper), although the use of optical fiber cable is growing rapidly in telecommunication systems as larger and larger amounts of data are transmitted. Additionally, as data transmissions increase, the fiber optic network is being extended closer to the end user which can be a premise, business, or a private residence.

Service providers are looking for simpler, more efficient equipment and installation methods for the last mile of the fiber to the home (FTTH) networks which is necessitated by the sheer volume of connections that need to be made. Current plug and play solutions today are limited.

Today, service providers can use pre-stubbed terminals such as OptiSheath® MultiPort Terminals with OptiTap® cable assemblies, both available from Corning Optical Communications, LLC (Hickory, N.C.). Similar products are available from Commscope. Engineered drop cables are factory prepared and come in standard cable lengths with hardened optical fiber connectors installed on at least one end of the drop cable. When utilizing these systems, the service provider need to know exactly which product will be used in which location in their networks so that they can purchase the correct length of drop cable. This can make sourcing and logistics difficult due to the complexities and variability from job site to job site.

More recently, field installed connectivity solutions are emerging that provide increased flexibility in addressing issues in the final drop to the customer premises. Field installing optical fiber connectors provides the flexibility of cutting the fiber drop and distribution cables to length at the job site which can save material costs for the cables, but which can require the use of more highly skilled craft to install the network.

While fiber terminals and enclosures can be custom configured for a given application in the factory, they do not always provide the flexibility/versatility in the field required by the rapid deployment of today's fiber to the home network expansion. Thus, there is a need for simple, modular plug and play terminal solutions that can be assembled at a factory or in a garage, and quickly and easily installed in the field by a lower skilled technician. This method allows a custom configuration that is adaptable over time, but doesn't require the presence of a highly skilled technician at the time of installation. Further, the final configuration work can be done inside a truck, removing one module of the closure, instead of on a ladder or bucket truck, or requiring the removal of the entire closure and all the associated slack cable to the truck.

### SUMMARY OF THE INVENTION

In a first embodiment, an advanced port entry device for a telecommunication enclosure is described. The port entry device comprises a sealing body having an internal passageway extending from a first end of the sealing body to a second end of the sealing body that is configured to be inserted at least partially into and engage with a port of the telecommunication enclosure, wherein the sealing body has an internal, and a support member extending from the first end of the sealing body wherein the support member is configured to pass through the port so that it resides within the protected interior space of the telecommunication enclosure when the port entry device is installed. The tray member includes an optical component holder disposed on a base of the tray member, wherein the optical component holder is configured to hold cable connection components.

In a second embodiment, an advanced port entry device for a telecommunication enclosure is described. The port entry device comprises a sealing body having an internal passageway extending from a first end of the sealing body to a second end of the sealing body that is configured to be inserted at least partially into and engage with a port of the telecommunication enclosure, wherein the sealing body has an internal, and a tray member extending from the first end of the sealing body, wherein the tray member is a double sided tray member having a first functional side and a second functional side and wherein the tray member is configured to pass through the port so that it resides within the protected interior space of the telecommunication enclosure when the port entry device is installed.

In a third embodiment, a port entry device for a telecommunication enclosure having an environmentally protected interior space, comprises a sealing body configured to engage with a port of the telecommunication enclosure and a tray member extending from the first end of the sealing body. The sealing body has an internal passageway extending from a first end of the sealing body to a second end of the sealing body, and the support member is configured to pass through the port so that it resides within the protected interior space of the telecommunication enclosure. The support member has a closed configuration having a first cross-section to pass through the port and an open configuration having a second cross-section, wherein the second cross-section is larger than the first cross-section.

In a fourth embodiment, an advanced port entry device allow passage of an elongated object into an environmentally protected interior space within a sealed enclosure. The port entry device comprises a sealing body configured to sealingly engage with a port of the telecommunication enclosure and a tray member extending from the first end of the sealing body that holds a component attached to the elongated objects, the tray member being configured to pass through the port so that it resides within the protected interior space of the enclosure. The sealing body has an internal passageway extending from a first end of the sealing body to a second end of the sealing body to allow passage of the elongated object through the sealing body.

The above summary of the present invention is not intended to describe each illustrated embodiment or every implementation of the present invention. The figures and the detailed description that follows more particularly exemplify these embodiments.

### BRIEF DESCRIPTION OF THE DRAWINGS

The present invention will be further described with reference to the accompanying drawings, wherein:

FIGS. 1A-1C are three views of an exemplary port entry device according to an embodiment of the present invention.

FIGS. 2A-2D show the assembly of the exemplary port entry device of FIGS. 1A and 1B disposed on the end of a preterminated cable into a port of a fiber optic terminal.

FIGS. 3A and 3B show two variations of another embodiment of an exemplary port entry device according to the present invention.

FIGS. 4A and 4B show an isometric view of third embodiment of an exemplary port entry device shows according to the present invention.

FIGS. 5A-5C shows three views of a fourth embodiment of an exemplary port entry device shows according to the present invention.

FIG. 6 shows an isometric view of a fifth embodiment of an exemplary port entry device shows according to the present invention.

FIGS. 7A-7C are three views of a sixth embodiment of a port entry device shows according to the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF THE EMBODIMENTS

In the following detailed description of the preferred embodiments, reference is made to the accompanying drawings, which form a part hereof, and in which is shown by way of illustration specific embodiments in which the invention may be practiced. The illustrated embodiments are not intended to be exhaustive of all embodiments according to the invention. It is to be understood that other embodiments may be utilized and structural or logical changes may be made without departing from the scope of the present invention. The following detailed description, therefore, is not to be taken in a limiting sense, and the scope of the present invention is defined by the appended claims.

An advanced port entry device for a telecommunication enclosure is described herein that both ensures an environmentally protected interior space within the telecommunication enclosure while simultaneously including a multi-functional tray member that can be inserted into the enclosure through one of the cable ports of the enclosure (e.g. an oval cable port). When referring to an environmentally protected space, no moisture (i.e. water), bugs or dust may enter the interior space of the enclosure when the enclosure or terminal is in a closed and sealed state and all of the ports are outfitted with environmentally sealing inlet devices/port entry devices that are designed to provide a watertight or water resistant seal and/or to prevent dust, bugs or any other foreign substance from entering the telecommunication enclosure.

The advanced port entry device enables the craft to prepare the advanced port entry device at an alternate location, and then simply plug the port entry device into the enclosure through one of the cable ports. The preparation work can include, for example, mounting the entry device on an optical fiber cable, terminating the end(s) of the optical fiber(s) with either optical fiber connectors and/or splices; stowing the optical fiber connectors, splices and/or slack fiber in/on the tray member of the port entry device; and/or installing an optical/optoelectronic device on the tray member. For example, a mid-span cable breakout may be stored on a tray attached to the oval entry port device. The fragile optical fibers are protected in a tray during handling of the cables. The exemplary port entry device can be used in an integrated fiber terminal or telecommunication enclosure to provide rapid field swap-ability and modification of the components used in the terminal and the functionality realized by the terminal or telecommunication enclosure.

In one exemplary aspect, the exemplary port entry device can be factory installed on an optical fiber cable along with pre-term connector pigtails, which may be stored in the tray member. In an alternative aspect, the exemplary port entry device can be field installed on an optical fiber cable at a location that is remote from the enclosure location which is especially advantageous when the telecommunication enclosure or terminal is disposed either in a hand hole/man hole below grade or in an aerial setting such as when the fiber enclosure is pole mounted, strand mounted or disposed on a wireless tower, for example.

The exemplary port entry device may be fitted on to a telecommunication cable, such as an optical fiber cable, and inserted into a port in a telecommunication enclosure to secure the telecommunication cable in the port. The optical fiber cable will contain one or more optical fibers. In some cables, the optical fibers may be grouped together in fiber ribbons or protective tubes. Each optical fiber will have a polymeric coating that surrounds and protects the central glass fiber. The strength members are generally in the form of at least one semi-rigid rod of compacted aramid fibers. If more than one of these semi-rigid strength members is present in the multi-fiber cable, they may be positioned around the optical fiber ribbon cable or the protective tubes. Alternatively the multi-fiber cable may have a combination of a semi-rigid central strength member and a plurality of loose or woven flexible strength members surrounding the optical fiber ribbon cable or the protective tubes. A cable jacket surrounds and protects the optical fibers and the strength members.

Alternatively, the telecommunication cable may be a metal armored cable, an electrically conductive cable having a plurality of twisted pair copper wires, coax cables or other electrically conductive cables which are typically found in telecommunication networks. In yet another aspect of the invention, the telecommunication cable may be a hybrid cable containing both optical fibers and electrical conductors.

Depending on the communication network architecture, the telecommunication enclosure may be a buried closure, an aerial closure or terminal, a fiber distribution hub, or an optical network terminal in the outside plant; or a wall mount communication box, terminal, fiber distribution hub, a wall mount patch panel, or an optical network terminal in premise applications.

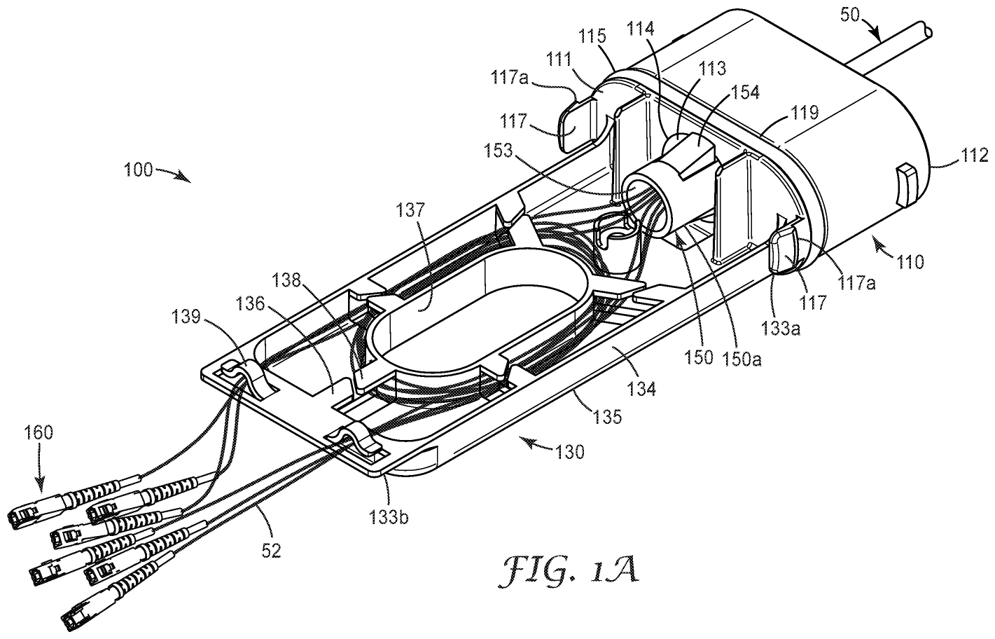

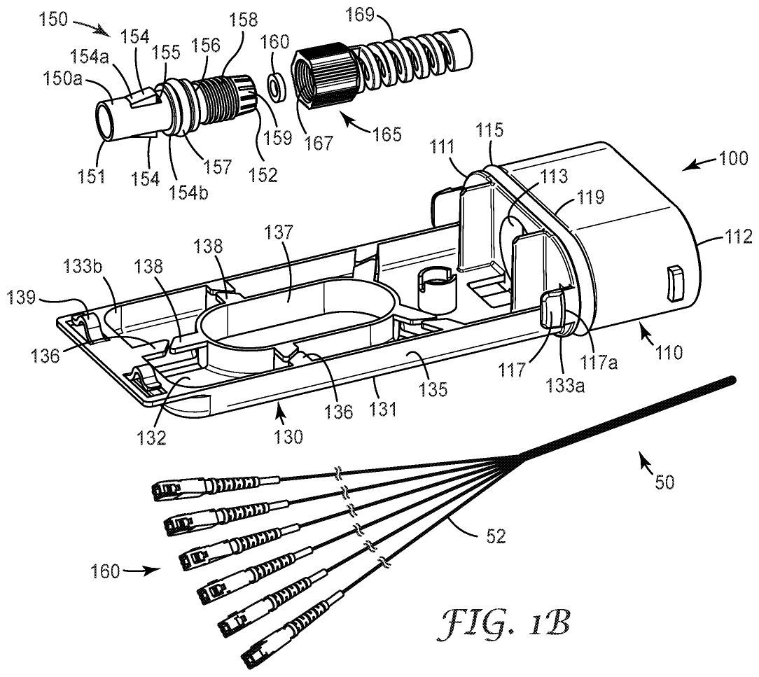

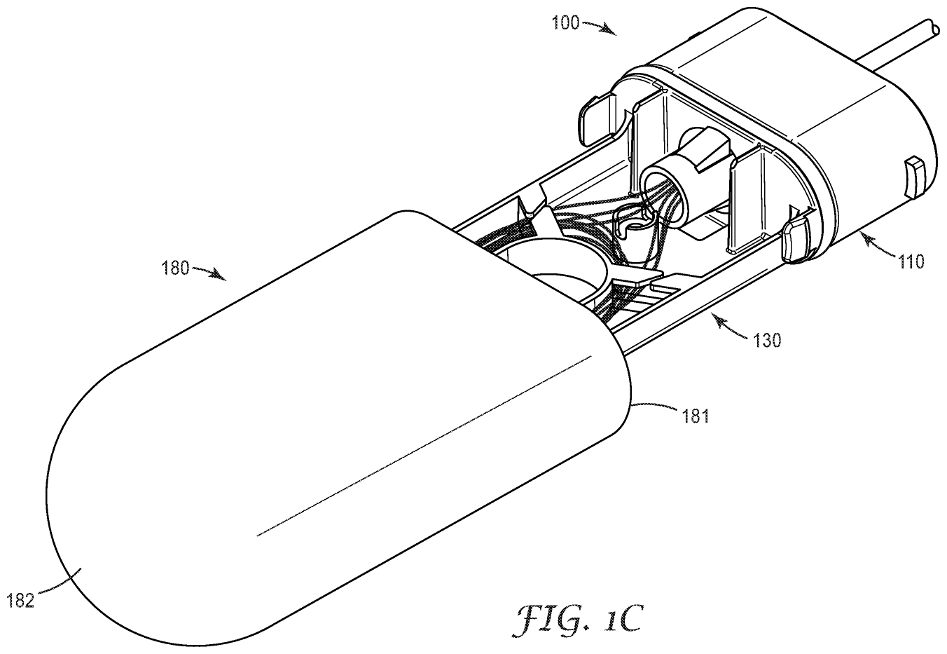

FIGS. 1A and 1B show a first embodiment of an exemplary port entry device 100 according to an embodiment of the present invention. Port entry device 100 comprises a sealing body 110 having a first end 111 and a second end 112 and an interior passageway 113 extending from a first end of the sealing body to a second end of the sealing body, wherein the sealing body is configured to sealingly engage with a port of the telecommunication enclosure or fiber terminals, and a support or tray member 130 extending from the first end of the sealing body. Tray member 130 is configured to pass through the port of the telecommunication enclosure or fiber terminals so that it resides within the protected interior space of the telecommunication enclosure when the exemplary port entry device is fully installed.

The sealing body 110 can be generally tubular in shape having an elliptical cross section. For example the port entry device can have an oval cross-section, an obround cross-section or a circular cross-section. The external size and shape of the sealing body should be close fitting with the port into which it will be installed. The sealing body includes an interior passageway 113 that extends along the length of the sealing body from the first end 111 to the second end 112 of the sealing body. The interior passageway can have an oval cross-section, an obround cross-section or a circular cross-section. In the exemplary embodiment shown in FIGS. 1A and 1B, the sealing body has an obround cross-section and the interior passageway has a circular cross-section.

The interior passageway may be configured to accommodate an inlet device 150 which holds and seals the cable within the port entry device. Inlet device 150 can be inserted into the second end 112 of the interior passageway 113 of sealing body 110. In this embodiment, the external size and shape of the inlet device is close fitting with the interior passage of the sealing body. Inlet device 150 will be described in detail below.

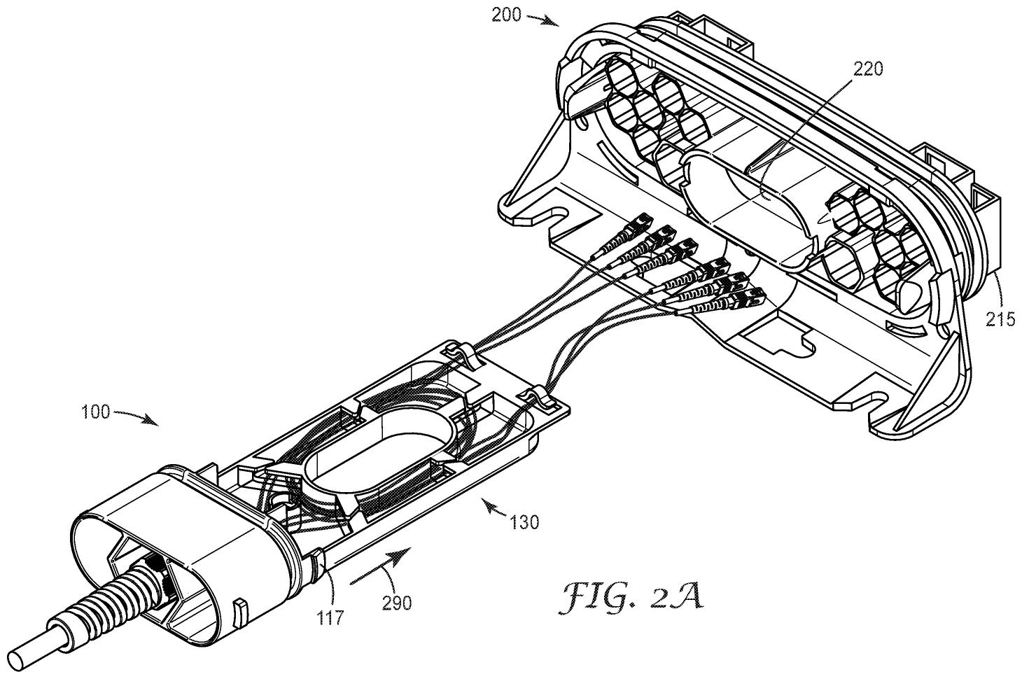

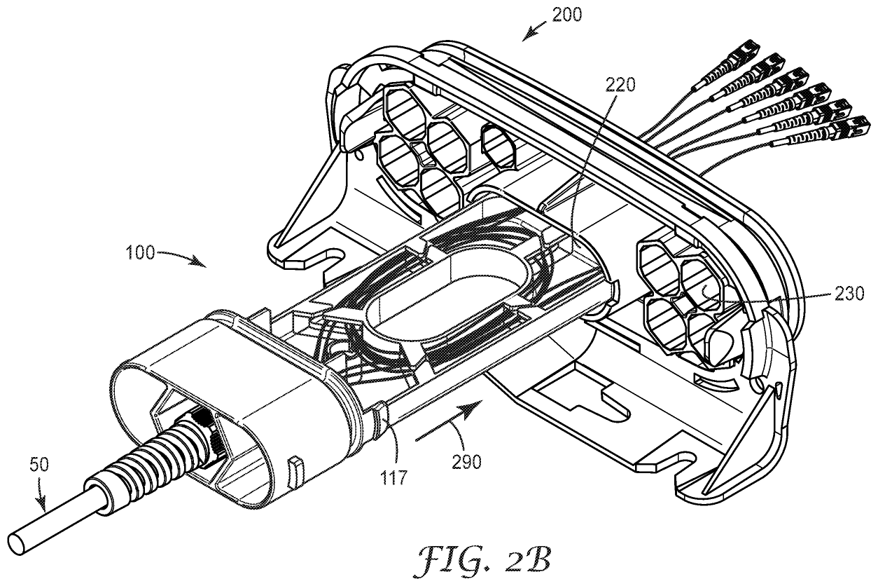

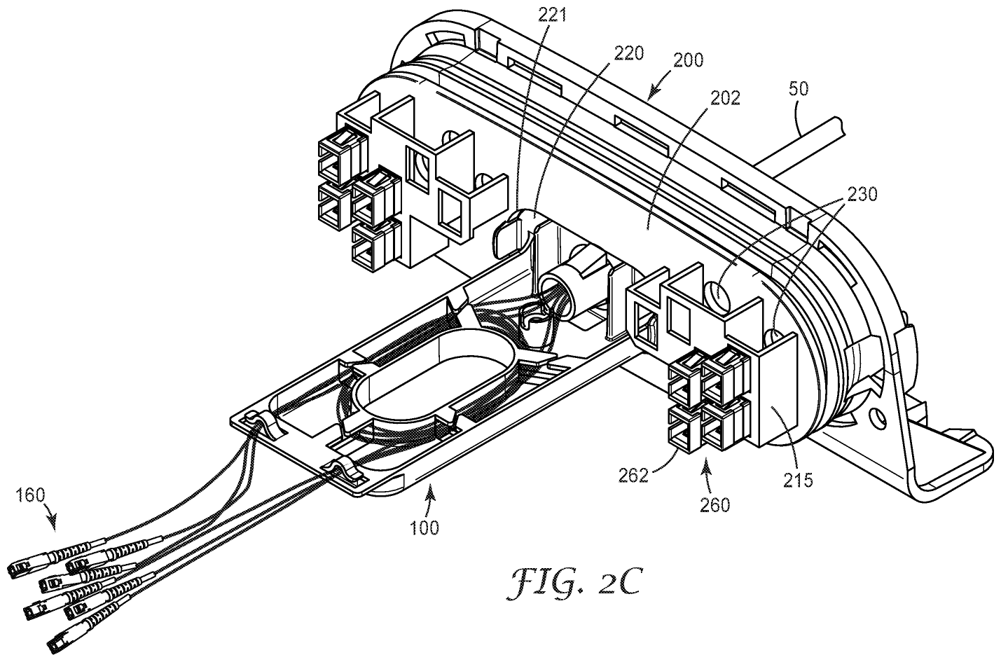

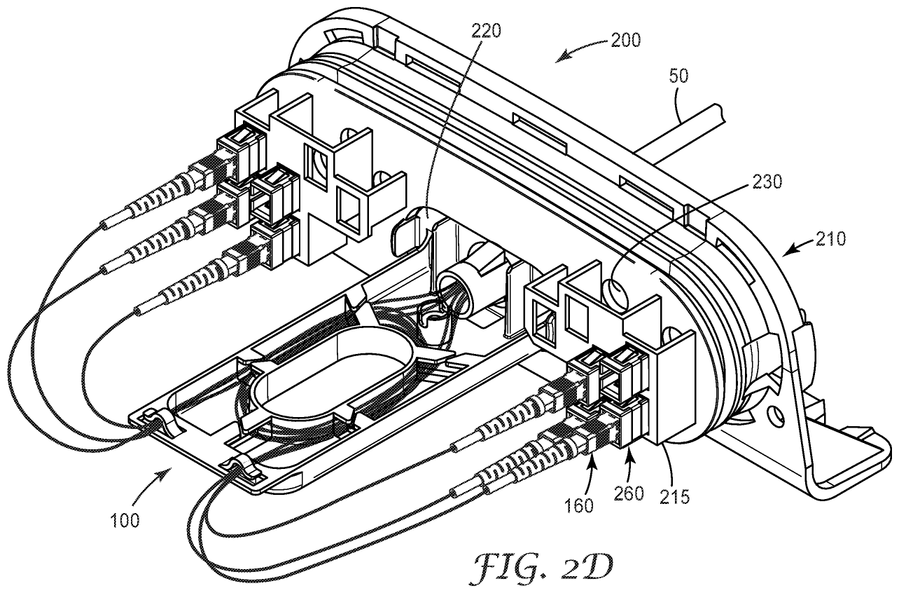

The sealing body 110 can include a pair of resilient arms 117 located on opposing sides of the first end 111 of the sealing body to secure the exemplary port entry device 100 in the port 220 in the base portion 200 of a fiber optic terminal as shown in FIG. 2D. At the end of each of the arms 117 is a latch structure such as a barb or lip 117a that engages with the edge 221 of port 220 to securely retain port entry device 100 when fully inserted as shown in FIG. 2C. When the port entry device is inserted into the port of a telecommunication enclosure, proper positioning can be confirmed by an audible click as the latch structures engage with the edges of the port. To remove the port entry device 100, the terminal ends of the resilient arms are pressed inward toward the centerline of the sealing body 110 until the port entry device can be slipped out of the port.

A groove 119 can be formed in the external surface of the sealing body 110 between the first end 111 and the second end 112 of sealing body to receive an external sealing member 115 such as an obround o-ring. This external sealing member provides an environmental seal between the port entry device 100 and a port of a telecommunication enclosure when the port entry device is fully seated therein.

Referring to FIGS. 1A-1B, an exemplary inlet device 150 includes a housing 150a having a first end 151 and a second end 152, an internal sealing member 160 shaped to be received within the second end of the housing, and a compression member 165 attachable to the second end of the housing. The housing may be generally cylindrical in shape and includes a passage 153 extending through the housing from the first end 151 to the second end 152 that accommodate certain categories of telecommunication cables 50 including single fiber drop cables, multi-fiber cables, copper communication cables or coax cables. The compression member 165 may be a cable securing/strain relief device, a clamping nut, or device capable of applying a radial force to the second end of the inlet device housing. The inlet device 150 can be formed of plastic by conventional methods, for example by injection molding.

The housing 150a can have a securing zone adjacent to the first end 151 of the housing. The securing zone may include one or more locking elements 154 which protrude from the sides of the housing 150a. In an exemplary embodiment, inlet device 100 has a pair of locking elements disposed on opposite sides of housing wherein the locking elements have a deformable cantilever structure which can flex when depressed. The cantilever structure has a free end 137 opposite where the cantilevered structure attaches to the housing. The attachment point of the cantilever structure acts as a living hinge 154a for the cantilever structure allowing the free end 154b to be depressed by applying an inward radial force. When depressed, the free end of each the cantilever structure can move into gap 155 formed between the telecommunications cable 50 inside the inlet device and the cantilever structure, such that the cantilever structures do not protrude beyond the external surface of the housing in that region when depressed. In this state, the inlet device may be inserted into or removed from a close fitting interior passageway 113 of port entry device 100. After insertion, the locking elements are released so that they protrude beyond the exterior surface of the housing to lock the inlet device within the port entry device 100.

The cantilever structure of locking elements 154 can be created by cutting the cantilever structures free of the housing 150a on three sides or can be created when the housing is formed (e.g. by an injection molding). In an alternative embodiment, the locking elements may be spring loaded and/or have a hinge pin connecting the locking element to the housing of the inlet device. Alternatively, more than two locking elements may be used. Preferably, the locking elements are spaced evenly around the circumference of the housing. In yet another embodiment, the securing zone may include a receiving channel into which a forked locking device may be inserted to secure the inlet device into a port of a telecommunication enclosure.

A groove 156 may be located between the securing zone and the second end 152 of housing 150a to receive an external sealing member 157, such as an o-ring. This external sealing member can provide an environmental seal between the inlet device and the inside surface of the interior passageway of the port entry device, when the inlet device is fully seated therein.

The housing 150a can have an external threaded portion 158 located between groove 156 and the second end 152 of the housing 150a. The external threaded portion 158 cooperates with a corresponding internal threaded portion 167 of a compression member 165 to cause a compressible portion 159 of the housing 150a to conform to an outer surface of the communication cable passing through passage 153 of the inlet device.

The compressible portion 159 is formed at the second end 152 of the housing. The compressible portion 159 may be reduced in size (diameter) when an external radial force is exerted on it such as by application of compression member 165. Compressible portion 159 centers the telecommunication cable in the inlet device 150 when the inlet device is installed on the telecommunication cable. The compressible portion 159 may include a plurality of spaced apart flexible fingers which surround the exit of passage 153 at the second end 152 of the inlet device. The fingers may be squeezed together when compression member 165 is attached to the second end of the housing. An internal sealing member 160 can be fitted into the interior passageway 153 in the compressible portion 159 of the housing 150a to improve the sealing capability of the inlet device around a telecommunication cable. The tightening of the compression member over the collapsible portion of the housing compresses the internal sealing member to form an environmental seal between the telecommunication cable and the interior of passage 153. In some applications such as in premise installations, a lesser degree of environmental protection is required and the internal sealing member 160 may be omitted. In this case, the compressible portion of the housing directly grips the cable inserted therethrough.

Compression member 165 has an interior chamber having a first opening at the first end configured to fit over the second end of the inlet device housing 150a and a smaller second opening (not shown) at the second end of the compression member to accommodate the passage of a telecommunication cable 50 therethrough. At least a portion of the interior chamber can be tapered near the second end of the clamping nut so that the clamping nut will squeeze the spaced apart fingers in the compressible portion of the inlet device together when the clamping nut is secured to the second end of the inlet device housing. The chamber has an internal threaded portion 167 that can correspond to the external thread on the second end of the housing and/or the second end of the cable securing device to allow the compression member to be secured to the housing and/or the cable securing device. The compressible member can include a bend control boot 169 disposed at the second end of compression member 165 to control the radius of curvature of a telecommunication cable as it exits the inlet device. In one aspect the bend control boot can be integrally formed with the compression member or it can be formed as a separate part that can be inserted through the opening at the second end of the compression member and secured in the compression member when the compression member is secured to the second end of the inlet device.

In a first embodiment shown in FIGS. 1A-1B and FIGS. 2A-2D, tray member 130 can be a slack storage tray that is disposed at the first end 111 of the sealing body 110. In a first aspect, the tray member can be integrally formed with the sealing body via an injection molding process. In an alternative aspect, the sealing body and the tray member can be formed as separate parts which are joined together via mechanical fasteners, adhesive or by welding the two pieces together.

Support or tray member 130 can have characteristic width that is less than the width of the port through which the exemplary port entry device is to be installed. In one aspect, support or tray member can have a generally flat tray body. In an alternative aspect, the support member can have the shape of a bar or rod which serves as an attachment point or anchor for optical fiber cables or components.

In the exemplary embodiment shown in FIGS. 1A and 1B, tray member 130 has tray body 131 comprising a base 132 extending longitudinally from a first end 133a to a second end 133b. The first end of the base is attached to and extends from the first end 111 of sealing body 110. The base includes a side wall 135 that extends from the base from a first corner at the first end of the base around the second end of the base to a second corner at the first end of the base and a hub wall 137 disposed centrally in the tray member and extending from a surface of the base. The space between the side wall and the hub wall define an optical fiber storage area with the hub wall acting as a bend control surface for the lengths of optical fiber stored in the tray member.

A plurality of tabs 136, 138 can extend from the top edges of the side wall and the hub wall over the fiber storage area of the tray member to help retain and manage the optical fibers within the boundaries of the tray body.

Tray member 130 can include one or more clips 139 disposed at the first end of the tray to retain and help organize the optical fibers as they exit the tray body. The embodiment includes two clips to divide the optical fibers stored in the tray into two subgroupings.

Port entry device 100 enables the craft to prepare and handle the terminal end of an optical fiber cable 50 at a location that is remote from the installation location which is especially advantageous when the telecommunication enclosure or terminal is disposed either in a hand hole/man hole below grade or in an aerial setting such as when the fiber enclosure is pole mounted, strand mounted or disposed on a wireless tower, for example. After the optical fiber cable is prepared, the prepared ends of the cable and any excess lengths of optical fiber can be stowed in the tray member of the exemplary port entry device. The craftsman can then simply plug the port entry device into the enclosure through one of the cable ports, complete any final connections if needed and close the enclosure completing the installation. The preparation work can include, for example, mounting the entry device on an optical fiber cable, terminating the end(s) of the optical fiber(s) with either optical fiber connectors and/or splices; stowing the optical fiber connectors, splices and or slack fiber in/on the tray member of the port entry device; and/or installing an optical/optoelectronic device on the tray member. For example, a mid-span cable breakout may be stored on a tray attached to the oval entry port device. The fragile optical fibers are protected in the tray member during handling of the cables.

The exemplary port entry device can be used in an integrated fiber terminal or telecommunication enclosure to provide rapid field swap-ability and modification of the components used in the terminal and the functionality realized by the terminal or telecommunications enclosure.

In another aspect, the exemplary port entry device 100 can be factory installed on a multi-fiber optical fiber cable, such as cable 50 in FIG. 1B, that includes an optical fiber connector 160 disposed at the end of each optical fiber 52 in the cable. Any excess length of the optical fibers and/or the optical fiber connectors can be stored in tray member 130. In an exemplary aspect, a temporary cover 180 can be installed over tray member 130 of port entry device 100 to protect the excess length of the optical fibers and/or the optical fiber connectors can be stored in tray member. Cover 180 shown in FIG. 1C is generally domed shaped having an internal cavity extending from an open end to a closed end that is configured to house the tray member.

In an exemplary embodiment, the open end of the cover may extend at least partially over and be closely fitted to the sealing body of port entry device 100 to provide an environmentally protected space within the interior cavity. In one aspect, the cover protects the fibers and connectors disposed in the tray member during transportation and storage, but the sealed cover allows the cable with the port entry device to be installed in the field when the network is being laid out. A second crew can come back at a later time and remove cover 180 to permit installation of the port entry device 100 into a port of a telecommunication enclosure or terminal, such as port 220 in base portion 200 of an enclosure shown in FIG. 2A. While cover 180 is described with respect to port entry device 100, use of a similar style cover is contemplated as an optional feature that could be used with any of the port entry devices described herein. In an alternative aspect, the port entry device and cover can comprise a permanent micro enclosure in their own right.

FIGS. 2A-2D illustrate the insertion of an exemplary port entry device 100 into a port 220 in a base portion 200 of an optical fiber enclosure or terminal. An exemplary optical fiber enclosure is described in U.S. Pat. No. 9,513,451, which is incorporated herein by reference in its entirety.

The exemplary optical fiber enclosure can include a base portion 200 of a fiber terminal having an inner wall and a cover (not shown) that can be positioned on the base portion to form a protective housing. A sealing gasket can be placed between the base portion and the cover to improve the environmental protection of the interior of the protective housing when the cover is assembled on to the base. The base portion can include a plurality of cable ports extending therethrough to permit passage of a cable into the interior of the protective housing. In an exemplary aspect, the base portion includes central entry opening or port 220 that is larger than the remaining cable ports which will hereinafter be referred to as drop cable ports 230. In an exemplary aspect, port 220 is shaped to accept port entry device 100 therein.

In the exemplary embodiment shown in FIGS. 2A-2D, the base portion can be configured to support the interconnection of optical fiber connectors within the interior of the protective housing. In particular, a holding structure 215 that is configured to hold optical fiber connector adapters 260 can be disposed in the protective housing of the optical fiber enclosure, wherein the connector adapters can be used to optically interconnect two optical fiber connectors 160. In the aspect shown in FIGS. 2C and 2D, the holding structure 215 can be integrally molded with the base portion to hold the optical fiber adapters in proximity to the drop cable ports 230. In an alternative aspect, holding structure 215 can be a separate structure that can be mounted to the base or another structure within the interior of the telecommunication enclosure.

In this configuration, connector adapters 260 are configured to accept a first optical connector inserted through one of the drop cable ports and a second standard format optical connector (e.g. SC-format optical connectors, LC-simplex format optical connectors, LC-duplex format optical connectors and MT-format optical connectors) from within the enclosure.

In an alternative aspect, the connector adapters 260 can be disposed at least partially within the drop cable ports to facilitate mating of two fiber optic connectors or the adapters can be held by a holding structure disposed well within the interior of the protective housing.

To install the port entry device 100 in a telecommunication enclosure, the port entry device is aligned with the port 220, as shown in FIG. 2A, and the optical fiber connectors are fed through the port 220. The port entry device is slid into the port as indicated by directional arrow 290 in FIG. 2B until the barbs 117a on resilient arms 117 engage with the edge 221 of port 220 to securely retain port entry device 100 within the port, as shown in FIG. 2C. Connectors 160 can be plugged into a first side 262 of connector adapters 260 that are secured in a holding structure adjacent to the inner wall 202 of the base portion. The connector adaptors can be held such that the second side of the connector adapter (i.e. the side opposite where connectors 160 are installed) can be accessed through drop cable ports 230 disposed through base portion 200 of the fiber terminal to allow an optical fiber connector to be inserted into the connector adapter from outside of the optical fiber enclosure.

Exemplary port entry device provides an easy plug and play installation of fiber optic enclosures and/or terminals. The exemplary port entry device 100 can provide compact storage and management of optical fibers within the enclosure or terminal. In one aspect, the cable can be prepared, connectorized and the excess fiber stored in the exemplary port entry device at a workstation located remotely from the telecommunication enclosure which can be very beneficial when the enclosure or terminal has been previously located in either a below grade location or in an aerial location where working space can be limited and/or awkward to access. Once assembled, the exemplary port entry device is simply plugged into the waiting port and the final connections made.

In an alternative aspect, the exemplary port entry devices of the present disclosure can be factory assembled on the end of an optical fiber cable. The prepared optical fiber cable is shipped to the job site where it is simply unwrapped and plugged in to an awaiting enclosure or terminal.

In another aspect, the exemplary port entry devices can be used in a prestubbed enclosure or terminal which in combination with ruggedized or weather resistant optical fiber connector that can be plugged an optical fiber connector adapter disposed within the enclosure adjacent to one of the drop cable ports without having to open or remove the lid of the enclosure or terminal. Alternatively, enclosures or terminals with the exemplary port entry devices can provide mid-span access to telecommunication lines.

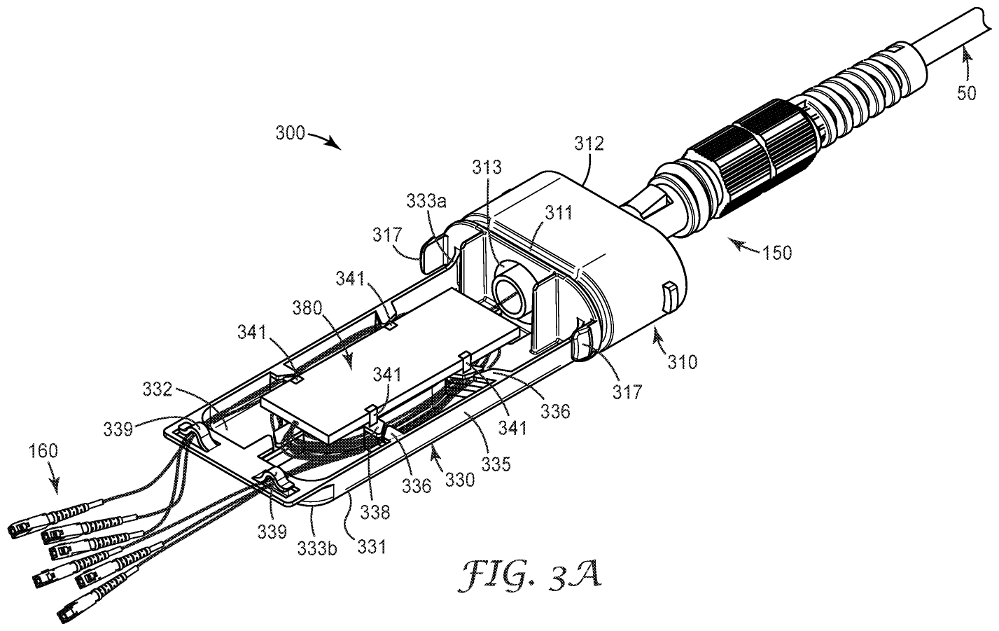

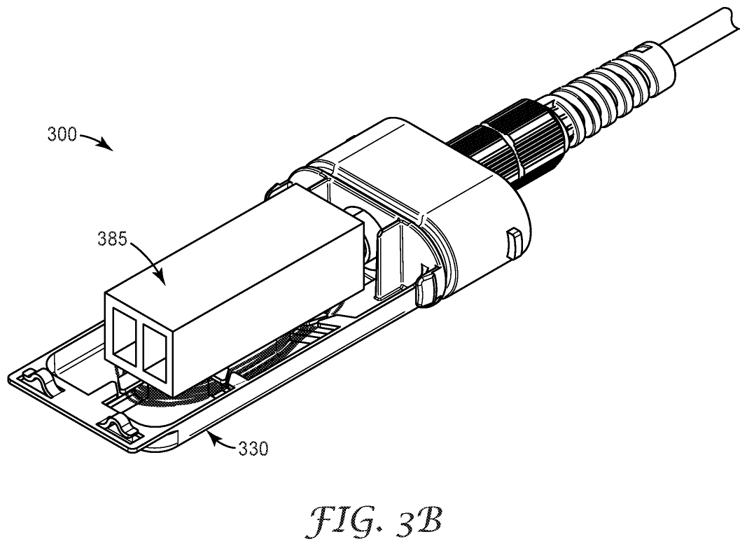

FIG. 3A shows another embodiment of an exemplary port entry device 300. Port entry device 300 is structurally similar to port entry device 100 described above in that port entry device 300 comprises a sealing body 310 having a first end 311 and a second end 312 and an interior passageway 313 extending from a first end of the sealing body to a second end of the sealing body and a sealing member disposed in a grove formed in the exterior surface of the sealing body to sealingly engage with a port of the telecommunication enclosure or fiber terminal, and a tray member 330 extending from the first end of the sealing body. Tray member 330 is configured to pass through the port of the telecommunication enclosure or fiber terminal so that it resides within the protected interior space of the telecommunication enclosure when the exemplary port entry device is fully installed.

The sealing body 310 can be generally tubular in shape having an elliptical cross section as described previously. The interior passageway may be configured to accommodate an inlet device 150 which holds and seals the cable within the port entry device. Inlet device 150 can be inserted into the second end 312 of the interior passageway 313 of sealing body 310. In this embodiment, the external size and shape of the inlet device is close fitting with the interior passage of the sealing body.

The sealing body 310 can also include a pair of resilient arms 317 located on opposing sides of the first end 311 of the sealing body to secure the exemplary port entry device 300 in the port 220 in the base portion 200 of a fiber optic terminal as shown in FIG. 2D. When the port entry device is inserted into the port of a telecommunication enclosure, proper positioning can be confirmed by an audible click as the latch structures engage with the edges of the port. To remove the port entry device 300, the terminal ends of the resilient arms are pressed inward toward the centerline of the sealing body 310 until the port entry device can be slipped out of the port.

Tray member 330 has tray body 331 comprising a base 332 extending longitudinally from a first end 333a to a second end 333b. The first end of the base is attached to and extends from the first end 311 of sealing body 310. The base includes a side wall 335 that extends around the edges of the base and defines a fiber storage area. A plurality of tabs 336, 338 extend from the top edges of the side wall and the hub wall (not shown) over the fiber storage area to help retain and manage the optical fibers within the boundaries of the tray body.

Tray member 330 can further includes provisions for securing at least one optical component 380 (i.e. catch structures 341). In one aspect, the optical component can be an optical component insert configured to hold a plurality of optical fiber splices, an optical splitter, an optical fiber fan-out device, an wavelength-division multiplexing (WDM) device, a small form pluggable (SFP) transceiver, etc. FIG. 3B shows a small form pluggable (SFP) transceiver 385 attached to tray member 330 which can be used in communication networks with transceiver ports where the craftsperson can unplug and remove the transceiver without opening the whole closure. This is important because transceivers are a low reliability component in the system and opening the closure has the potential to disturb other sensitive items. In particular, the SFP transceiver can be attached to the tray member for cellular networks where cellular radios commonly have transceiver ports. The exemplary port entry device enables the craftsperson to unplug and remove the transceiver without opening the whole large radio housing.

Tray member 330 can also include one or more clips 339 disposed at the first end of the tray to retain and help organize optical fibers exiting the tray body. The embodiment includes two clips to divide the optical fibers stored in the tray into two subgroupings.

The exemplary port entry device can be used in an integrated fiber terminal or telecommunication enclosure to provide rapid field swap-ability of optical components for repair or upgrade of an optical fiber enclosure or terminal. In another aspect, port entry device can provide swappable electronic, optical or opto-electronic access port. For example, the optical component could be an optoelectronic component such as a wireless radio transceiver, such as an SFP transceiver. In the case of field electronics, for example, service providers want to be able to replace or swap out the transceiver without opening up the remote radio.

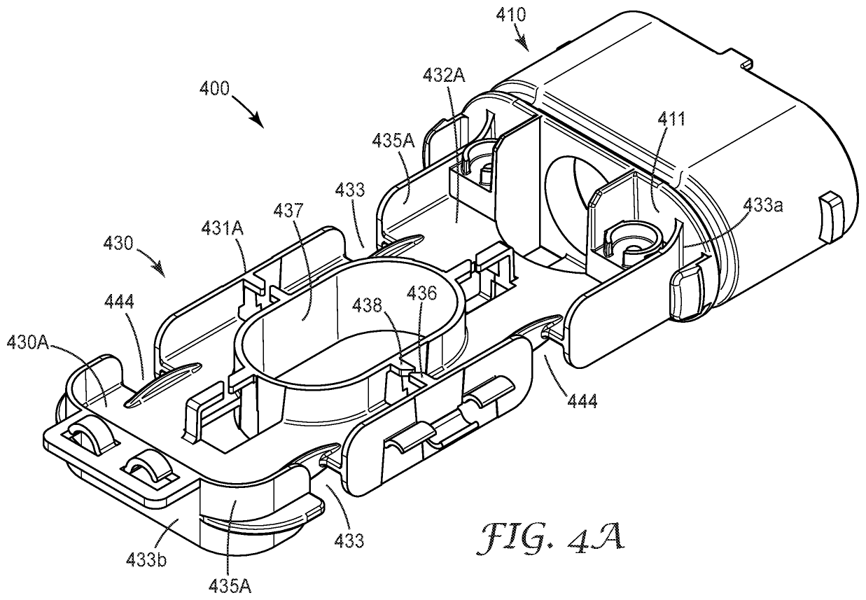

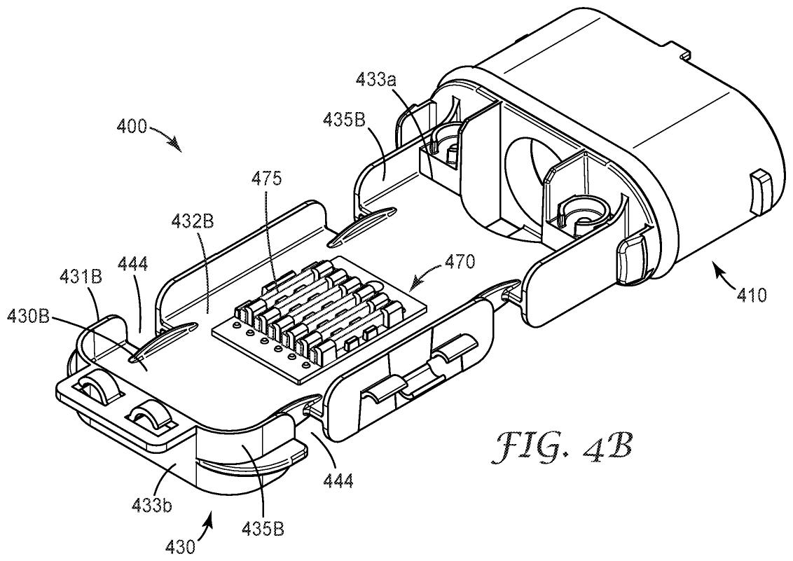

FIGS. 4A and 4B shows a third embodiment of an exemplary port entry device 400 according to the present invention. Port entry device 400 includes a sealing body 410 that is analogous to sealing bodies 110, 310 described previously and a double sided tray member 430. Tray member 430 of port entry device 400 is double sided to provide increased functionality. Tray member 430 includes a fiber storage side 430A and a fiber connection side 430B.

Fiber storage side 430A, shown in FIG. 4A, has a tray body 431A comprising a base 432A extending longitudinally from a first end 433a to a second end 433b. The first end of the base is attached to and extends from the first end 411 of sealing body 410. The base includes a segmented side wall 435A extending around portions of at least three edges of the base and a hub wall 437. The area between the segmented side wall and the hub wall defines a fiber storage area. A plurality of tabs 436, 438 extend from the top edges of the segmented side wall and the hub wall over the fiber storage area to help retain and manage the optical fibers within the boundaries of the tray body. The fiber storage area can be configured to provide buffer tube storage, 900 micron fiber storage of 250 micron fiber storage.

Tray body 431A can further include one or more fiber pass-throughs 444 to allow optical fibers to pass from the fiber storage side 430A and a fiber connection side 430B of tray member 430.

Referring to FIG. 4B, fiber connection side 430B has a tray body 431B comprising a base 432B extending longitudinally from a first end 433a to a second end 433b. The first end of the base is attached to and extends from the first end 411 of sealing body 410. The base includes a segmented side wall 435B extends around portions of at least three edges of the base. An optical component holder 470 can be disposed on the base, wherein the optical component holder is configured to hold cable connection components including optical fiber splices optical fiber splitters, WDM devices and/or optical fiber connector adapters.

In the exemplary embodiments shown in FIG. 4B, the optical component holder 470 is a splice holder that is configured to hold a plurality of optical fiber splices 475. In an exemplary aspect the optical fiber splices can be mechanical splices or fusion splices. The input optical fibers can be pre-installed in the optical fiber splice. For example, the terminal end of optical fibers can be pre-installed in mechanical fiber splice devices, after routing and storing excess fiber in the fiber storage side 430A.

Additionally, fiber connection side 430B can include a fiber splice actuation mechanism (not shown) positioned over the mechanical fiber splices, wherein the fiber splice actuation mechanism is capable of actuating the mechanical fiber splice by pressing on the actuation mechanism. In one embodiment, the fiber splice actuation mechanism comprises a flexible cantilevered arm that is integral to the tray. An exemplary tray mounted fiber splice actuation mechanism is described in United States Patent Publication No. 2016-0349472. Pre-installing the optical fiber in the port entry device 400 prior to splice actuation allows an installer to avoid torsion effects on the optical fiber.

The double sided tray member of port entry device 400 can be modified to address different applications found in communication networks. In one aspect, an exemplary port entry device can be provided with a mid-span access buffer storage tray member wherein both the first and second sides of the double sided tray member are used for slack storage for 250 micron optical fiber, 900 micron optical fiber, optical fiber ribbon cables, and/or buffer tube storage. For example, an optical fiber cable can be opened and stripped down to the buffer tube(s). Then, an end portion of each buffer tube(s) can be removed to reveal either 250 micron or 900 micron optical fibers. The buffer tubes can be stored on a first sides of a double sided slack storage tray member and the exposed tray member 250 micron or 900 micron optical fibers can be stored on a second side thereof. After preparation and storage of the buffer tubes and the optical fibers, at a convenient remote location, the port entry device can be inserted into an appropriate port of a telecommunication enclosure or terminal. The optical fibers can remain stored in the tray member until a connection needs to be made.

In another aspect, the double sided tray member can be configured to hold optical components on both sides of the tray. For example, a splice insert with optical fiber splices can be disposed on a first side of the tray member and one or more optical fiber splitters can be disposed on the second side of the tray member.

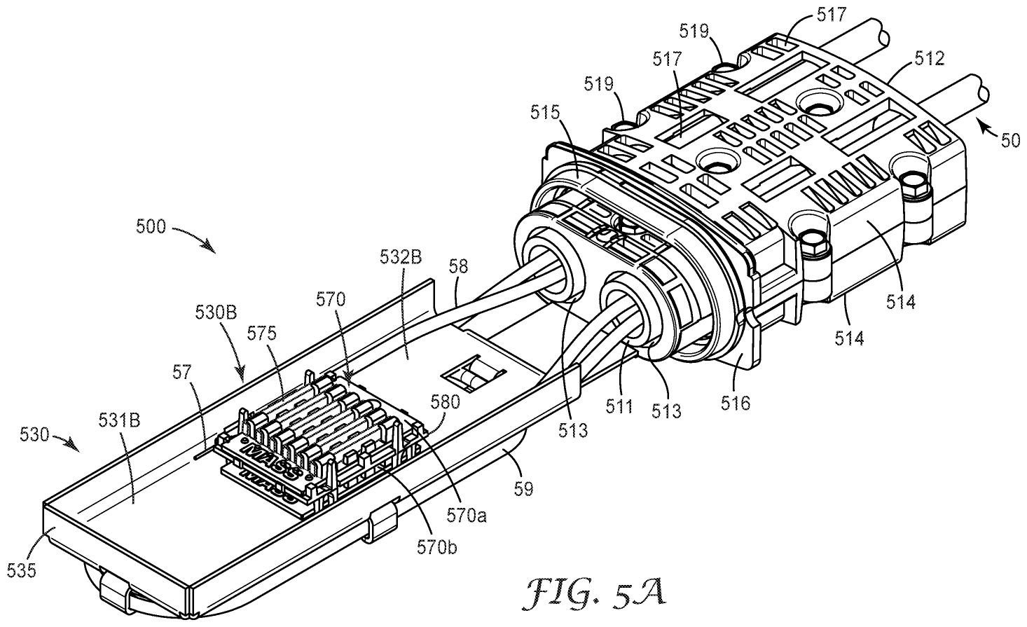

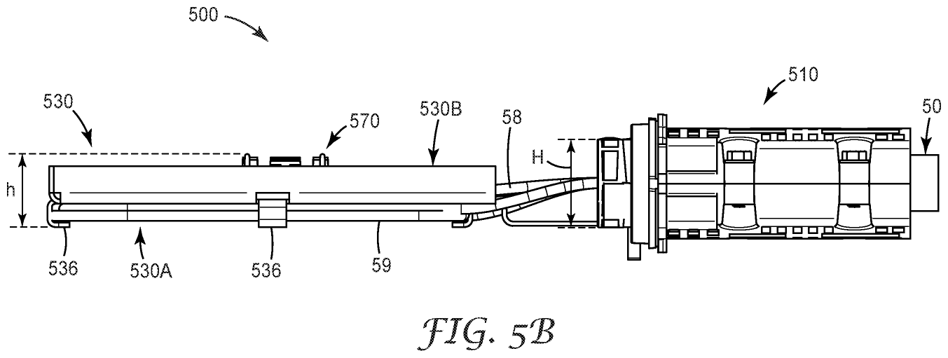

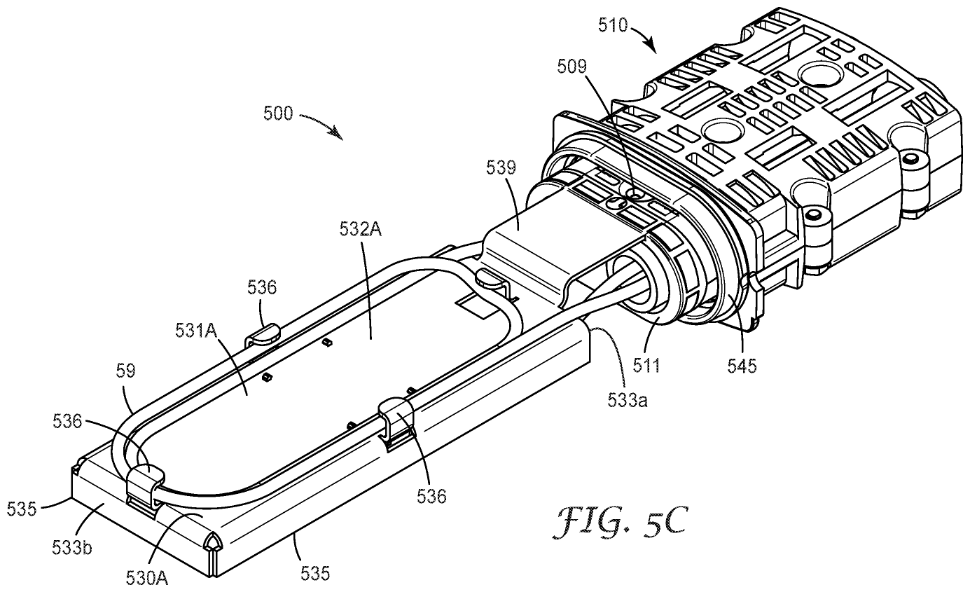

FIGS. 5A-5C illustrate a fourth embodiment of a port entry device 500 that includes a sealing body 510 having a first end 511, a second end 512 and a double sided tray member 530 having cable slack storage side 530A and a fiber connection side 530B. In an exemplary aspect, tray member can be formed from a bent piece of sheet metal which can be attached to a molded plastic sealing body by a mechanical fastener(s) 509. The tray member can have a tongue portion 539 that fits into a slot disposed in a first end of the sealing body and secured in place by mechanical fastener 509.

Sealing body 510 has two half shells 514 that can be secured together by mechanical fasteners such as screws 519. Each half shell includes at least on open channel that will form at least one passageway 513 that extends from the first end of the sealing body to the second end of the sealing body. In the exemplary embodiment shown in FIGS. 5A-5C, each half shell has two open channels formed in the interior surface that will form two passageways when the half shells are assembled together. A grommet(s) or mastic material can be used to provide an internal environmental seal between the cable(s) and the sealing body. In an exemplary embodiment, slit grommets can be used when the exemplary sealing body is used in conjunction with a loop of cable having at least one uncut optical fiber. In an alternative aspect, an elastomeric sealing material or an oil gel sealing material can be molded into each half shell to form an environmental seal when the two half shells are brought together. When soft flowable sealant materials, such as those mentioned above, are used to provide the environmental seal between the cable(s) and the sealing body, the sealing body can gave a plurality of openings or windows 517 extending through each half shell to allow for the displacement of the flowable sealant material when the two half shells are secured together. Openings or windows can also provide mechanical interlocking between the flowable sealant materials both prior to and after the two half shells are secured together.

A flange 516 can extend from the outer surface of each half shell 514 which will serve as an abutment surface against the port of the telecommunication enclosure or terminal into which the exemplary port entry device is to be inserted. A bracket and/or mechanical fasteners can be used to secure the exemplary port entry device in the port of the telecommunication enclosure or terminal. An external sealing member 515 can be disposed between the flange and the first end of the sealing body to provide an environmental seal between the sealing body and the port of the telecommunication enclosure or terminal.

Fiber storage side 530a of tray member 530, shown in FIG. 5C, has a base 532b extending longitudinally from a first end 533a to a second end 533b. The first end of the base is attached to tongue 539 that is secured to and extends from the first end 511 of sealing body 510. A plurality of tabs 536 extend from the base to hold and/or manage a cable adjacent to the base of the fiber storage side. The fiber storage area can be configured to provide one or more jacketed cables or internal fiber protection tubes 58. In an exemplary aspect, the fiber storage area can be configured to store uncut loop 59 of cable/protection tube having uncut optical fibers disposed therein. In an alternative aspect, the exemplary port entry device can be used at a midspan access location with two separate cables rather than a cable loop from a single cable.

The fibers to be accessed can be routed to the fiber connection side 530B of tray member 530 has a base 532B extending longitudinally from a first end 533a to a second end 533b. The base includes a side wall 535 extending around at least a portion of at least three edges of the base. An optical component holder 570 can be disposed on the base, wherein the optical component holder is configured to hold cable connection components including optical fiber splices optical fiber splitters, WDM devices and/or optical fiber connector adapters.

In the exemplary embodiment shown in FIG. 5A, optical component holder 570a is disposed on the base 532B, and optical component holder 570b is positioned over at least a portion of the first interconnection layer, wherein the second interconnection layer is disposed on a first repositionable mezzanine 580. An exemplary mezzanine is described in U.S. Pat. No. 9,494,760, herein incorporated by reference in its entirety.

In one aspect, the optical component holders 570 are splice holder that is configured to hold a plurality of optical fiber splices. The optical fiber splices can be mechanical splices or fusion splices. In the exemplary embodiments shown in FIG. 5A, the optical component holder 570a is mass fusion splice holder that can be used to efficiently splice two fiber ribbons together 575. For example a fiber ribbon 57 from an input cable 50 can be spliced to a ribbon fiber (not shown) in an output cable or to ribbon tailed fanout assembly (also not shown). In some embodiments, the fiber ribbon(s) from the input cable can be pre-installed in the optical fiber splices. For example, the terminal end of fiber 59 can be pre-installed in one of the splice devices 575, after routing and storing a loop of optical fiber cable in the fiber storage side 530A prior to insertion of the exemplary port entry device into the port of a telecommunication enclosure or terminal.

The first end of the sealing body that is inserted into the port of the telecommunications enclosure or terminal has a characteristic cross-sectional profile which is characterized by the width of the first end of the sealing body (refer to FIG. 5A) and a height, H, illustrated in FIG. 5B. The tray member which is also inserted through the port of the telecommunications enclosure or terminal will also have a cross-sectional profile, which is characterized by the width of the first end of the sealing body (refer to FIG. 5A) and a height, h. The cross-sectional profile of the tray member can be inscribed in the characteristic cross-sectional profile of the first end of the sealing body.

The sealing body 510 can be formed of any suitable plastic material by methods such as injection molding, extrusion, casting, machining, and the like. For example, these parts may be made of molded polypropylene, nylon, polypropylene/nylon alloys or glass filled versions of these polymers. Material selection will depend upon factors including, but not limited to, chemical exposure conditions, environmental exposure conditions including temperature and humidity conditions, UV exposure conditions, flame-retardancy requirements, material strength, and rigidity, to name a few.

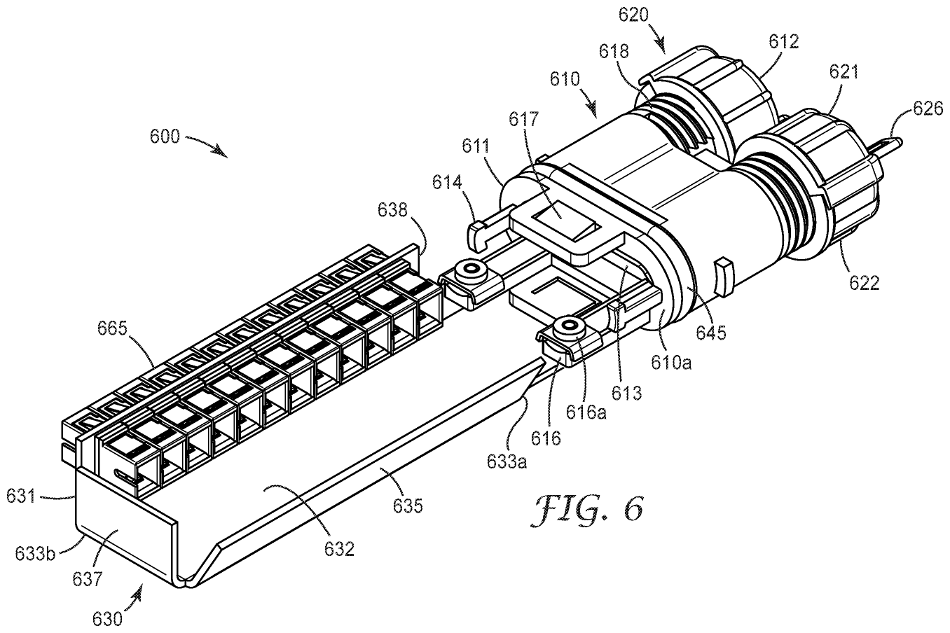

FIG. 6 shows a seventh embodiment of an exemplary port entry device 600. As before, port entry device 600 includes a sealing body 610 and a tray member 630. Sealing body 610 is analogous to sealing body 510 as described above. Tray member 630 extends from a first end of the sealing body. In this embodiment, tray member 630 is a fiber connection tray that is configured to support interconnection through the use of optical fiber connectors (not shown). Sealing body 610 includes an interior passageway 613 extending through the sealing body from a first end of the sealing body to a second end of the sealing body, pair of clamping nuts 620 attachable to the second end of the sealing body, and a tray member 630 extending from the first end of the sealing body, wherein the tray member is configured to pass through the port of the telecommunication enclosure or fiber terminals. In one aspect, sealing body 610 can have a structure similar to the inlet device described in U.S. Pat. No. 8,648,258, which is incorporated herein by reference in its entirety. Sealing body 610 and interior passageway 613 can be generally tubular in shape having an elliptical cross section. For example, port entry device can have an oval cross-section, an obround cross-section or a circular cross-section with the interior passageway having a correspondingly smaller shape. The interior passageway 613 may be configured to accommodate a plurality of certain categories of telecommunication cables including single fiber cables or multi-fiber cables, low pair count copper cables, coaxial cables or electrical/optical hybrid cables. In an exemplary aspect, port entry device 600 can accommodate a loop of cable where some of the optical fibers in the cable are uncut.

A pair of resilient arms 617 are located at the first end and on opposite sides of the sealing body. A free end of each of the resilient arms can engage with the edge 221 (FIG. 2C) of port 220 in the base 200 of a telecommunication enclosure to securely retain port entry device 600 in the enclosure when fully inserted, as described previously. Additionally, the sealing body 610 can optionally include at least one cable strain relief bracket 614 to strain relieve a cable passing through the interior passageway and/or at least one strength member strain relief bracket 616 extending from on the first end 610a of the sealing body. In FIG. 6, port entry device 600 includes two T-shaped strain relief brackets and two strength member strain relief bracket that are integrally molded with tray member 630. A cable tie may be secured around the cable jacket and the cable strain relief bracket(s) 614 to provide strain relief to the telecommunication cable, and a screw or other mechanical fastener 616a can be used to secure either rigid or flexible strength members to strength member strain relief bracket 616.

A groove (not shown) may be located between the first end 610a and the second end of sealing body 610 to receive an external sealing member 645 such as an o-ring to provide an environmental seal between the port entry device 600 and a port of a telecommunication enclosure when the port entry device is fully seated therein.

Sealing body 610 can have an external threaded portions 618 at the second end 612 of the sealing body 610. The external threaded portion 618 cooperates with a corresponding internal threaded portion of clamping nut 620 to secure the cable within the sealing body. The tightening of the clamping nut 620 pushes a split sleeve pushing member deeper (not shown) into sealing body to compressing internal sealing member(s) (not shown) around the communication cable. In some applications such as in premise installations, a lesser degree of environmental protection is required and the internal sealing member(s) may be omitted.

When working with a loop of uncut cable, clamping nut 620 includes a pair of nut portions 621, 622 that are keyed to lock together so that continuous internal threads (not shown) are formed. At least one of the nut portions 621, 622 can have a loop 626 extending from the second side of the nut portion. A cable tie (not shown) can be inserted through loop 626 once the nut has been tightened onto the sealing body 610 of the port entry device 600 and secured around the telecommunication cable to keep the clamping nut 620 securely in place.

Tray member 630 has a tray body 631 comprising a base 632 extending longitudinally from a first end 633a to a second end 633b. The base includes sidewalls 635, 637, 638 that extends around portions of at least three edges of the base. One of the side walls (i.e. sidewall 638) is configured to hold a plurality of optical fiber connector adapters 665 to create an optical fiber patch field.

In one exemplary aspect, sidewall 638 can extend perpendicularly from base. In another exemplary aspect, sidewall 638 can be disposed at an angle that deviates less than about 20° from perpendicular from the base, preferably having a deviation of less than or equal to 10° from perpendicular.

Sidewall 638 has at least one slot (not shown) that is configured to accept and hold a plurality of connector adapters 665. The number and length of the slots controls how many connector adapters that can be accommodated. For example, the embodiment shown in FIG. 6, can accommodate twelve SC format connector adapters. In an alternative, the tray member can be accommodate LC connector adapters.

Sidewall 635 can extend perpendicularly from base or it can be disposed at an angle relative to the base between about 15° and about 45° to facilitate insertion of the optical fiber connectors into the adapters 665.

In one aspect, a free end of the tray member (i.e. sidewall 637) can include a secondary coupling structure (not shown) to permit attachment to inside the telecommunication enclosure to provide added stability and/or vibration resistance.

In an exemplary embodiment, port entry device 600 can be factory mounted on to the end of a pre-terminated optical fiber cable in the factory such that the optical fiber connector(s) on the optical fibers are already plugged into the adapters when the port entry device arrives at the job site. The craftsman can simply plug the port entry device into a port of a telecommunication enclosure or terminal saving time and money associated with standard installations.

In another embodiment the port entry device for a telecommunication enclosure comprises a sealing body configured to sealingly engage with a port of the telecommunication enclosure, wherein the sealing body has an internal passageway extending from a first end of the sealing body to a second end of the sealing body, and a tray member extending from the first end of the sealing body that is configured to pass through the port so that it resides within the protected interior space of the telecommunication enclosure, the tray member having a closed configuration having a first cross-section to pass through the port and an open configuration having a second cross-section, wherein the second cross-section is larger than the first cross-section. In one aspect, the second cross-section is larger than the port through which the port entry device is inserted. This can be accomplished by the inclusion of at least one pivoting body rotatably attached to the tray member, such that the at least one pivot body is moveable from a closed configuration for insertion through the port and an open use configuration.

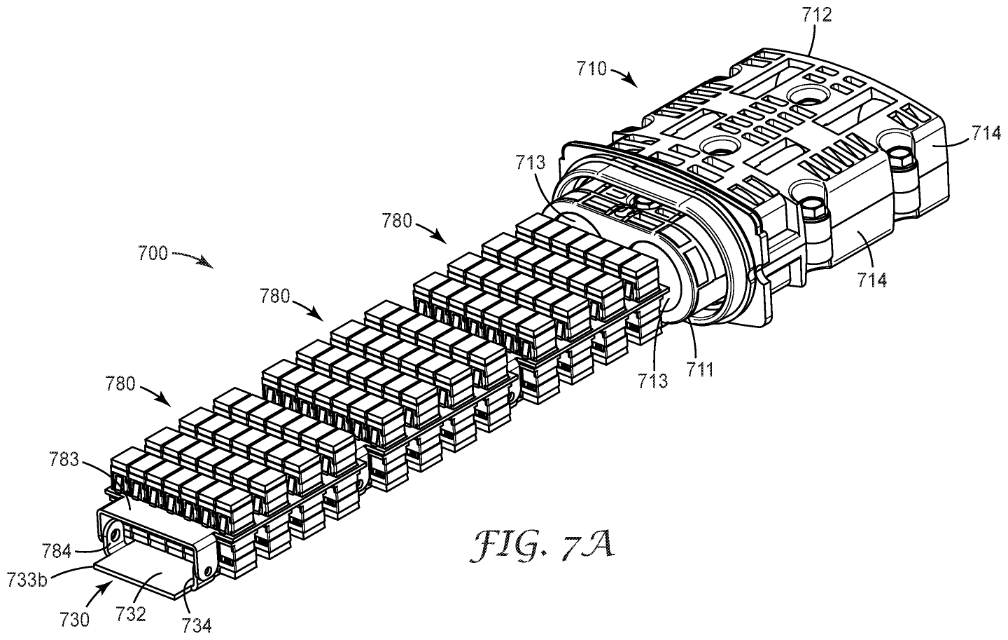

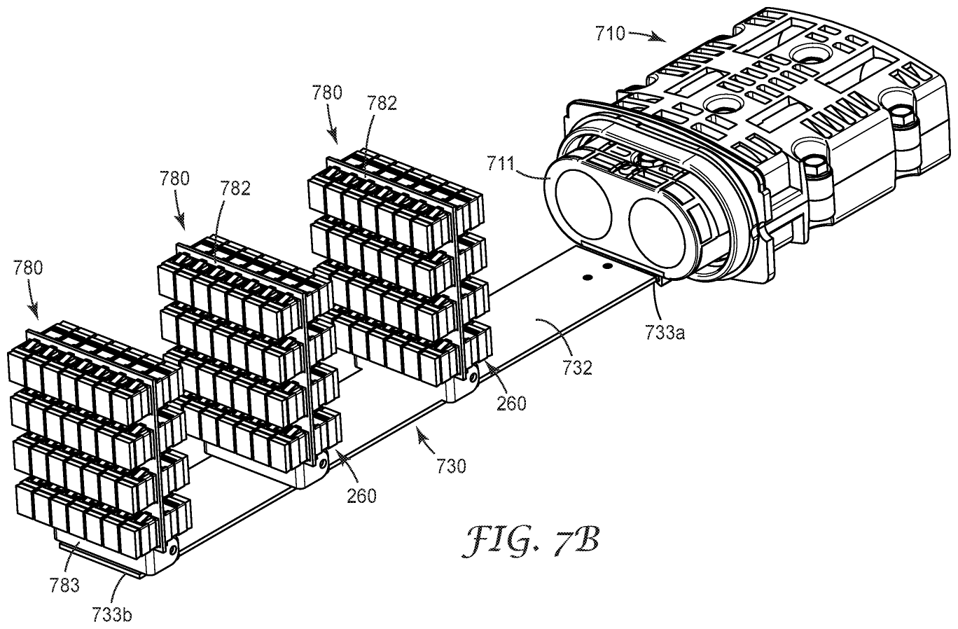

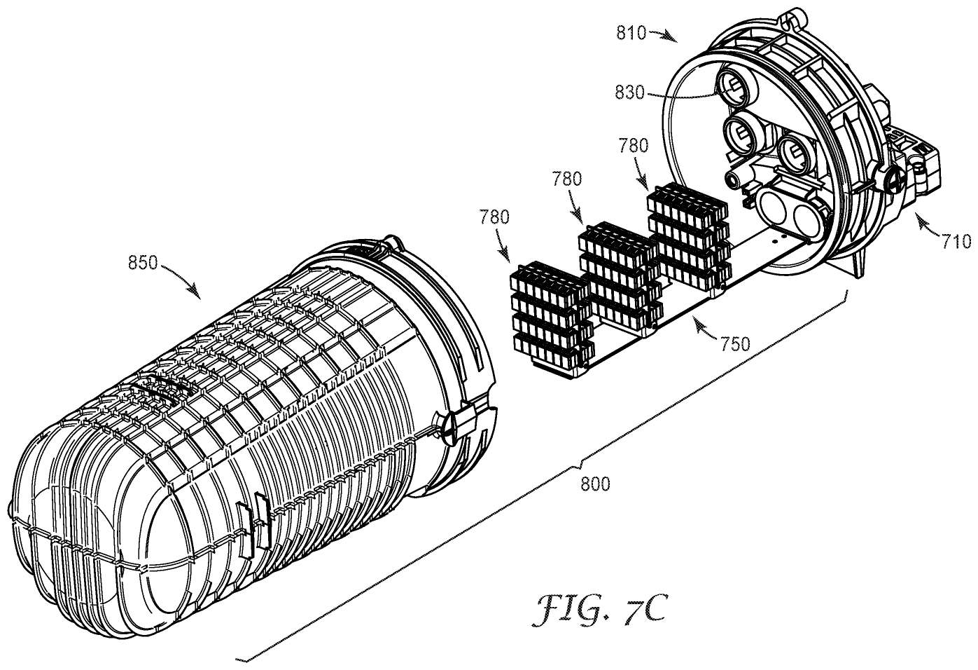

For example, FIGS. 7A-7C show a port entry device 700 that creates a larger, more-dense cross-connection or patch field that can be preassembled prior to insertion of the port entry device into telecommunication enclosure 800. Telecommunications enclosure 800 includes a base having a plurality of ports 830 and a dome shaped cover 850 that can be secured to the closure base 810 to create a protected internal space. In this embodiment, the internal space of the telecommunication closure can be better utilized by providing the patch fields on pivoting bodies 780 that can be deployed after insertion of the port entry device through a standard port in said enclosure. Advantageously, the increased fiber/connection port counts provided by port entry device 700 may allow for the deployment of fewer splice closures in a specific area of the network.

Port entry device 700 comprises a sealing body 710 having a first end 711 and a second end 712 and at least one interior passageway 713 extending from a first end of the sealing body to a second end of the sealing body and a support member 730 extending from the first end of the sealing body that includes a plurality of pivoting bodies 780 rotatably attached to said support member. Sealing body 710 is substantially the same as sealing body 510 described previously and the numbering of parts in the present embodiment will correspond to the same parts and relevant description for sealing body 510.

The sealing body is configured to engage with a port of the telecommunication enclosure or fiber terminal, such as the dome style telecommunication enclosure 800 shown in FIG. 7C. Support member 730 is configured to pass through the port of the telecommunication enclosure or fiber terminals so that it resides within the protected interior space of the telecommunication enclosure when the exemplary port entry device is fully installed.

The sealing body can be generally tubular in shape having a substantially elliptical cross section configured to fit securely in an oval or obround shaped port in a telecommunication enclosure or terminal. For example, in some embodiments, the port entry device can have an oval cross-section, an obround cross-section or a circular cross-section as shown previously. In an alternative aspect shown in FIGS. 7A-7C, sealing body 710 has two interior passageways 713 formed when the two half shells 714 are secured together. The external size and shape of the at least a portion of the sealing body should be close fitting with the port into which it will be installed. The interior passageway can have an oval cross-section, an obround cross-section or a circular cross-section. In the exemplary embodiment shown in FIGS. 7A-7C, the sealing body is derived from a sealing device such as the 27 mm Double Cable Entry Port (P/N 80-6113-2952-7) available from 3M Company (St. Paul, Minn.).

The exemplary port entry device 700, can be secured in the port by clips or latches as described previously or by mechanical fasteners such as screws and/or mechanical bracketing (not shown).

Support member 730 has tray body comprising a base 732 extending longitudinally from a first end 733a to a second end 733b. The first end of the base is attached to and extends from the first end 711 of sealing body 710. Base 732 includes a plurality of facing projections 734 extending from opposite sides of the base in pairs, best seen in FIG. 7A. Pivoting bodies 780 are rotatably attached between each pair of facing projections of the support member. The pivot bodies are moveable from a stored or closed configuration for insertion through a port of a telecommunication enclosure or terminal, shown in FIG. 7A, to an open or use configuration as shown in FIGS. 7B and 7C. In an alternative aspect, the base can include side walls extending at least partially along the longitudinal edges of the base where the sidewalls allow the pivoting members to be rotatably attached therebetween.

Each pivoting body 780 includes an adapter mounting plate 782 configured to hold a plurality of optical fiber connector adapters 260 and a connection flange 783 or pin extending from each side of the adapter mounting plate. The pivoting bodies are designed to pack densely for insertion into the enclosure, but expand to allow easy access to all of the connection ports of optical fiber connector adapters 260 after the exemplary port entry device has been installed in the enclosure. The connection flange 783 or pin is configured for mechanical attachment to the facing projections 734 or side walls of the support member in such a way that each pivot body can be moved from a stored or closed position to an open or use position.

The embodiment shown in FIGS. 7A-7C has 3 individually pivoting bodies holding 28 SC optical fiber connector adapters 260. The pivoting bodies can be rotated through any orientation from 0 degrees-135 degrees, depending on the need or application. The blocks could be expanded individually as the take rate demands, or mechanically integrated together to deploy as a single unit, employing such devices as a linkage bar fastening them together to maintain a spatial relationship to one another.

In an alternative aspect, other telecommunications devices could be deployed on the pivoting bodies, depending on the application, such as optical splitters, multiplexers, splices, fanouts, dedicated pass through connector sets, or combinations thereof. The size, shape, and count of the pivoting bodies mounted to the support member can be adjusted to maximize the usage of the interior space of the telecommunication enclosure. In some embodiments other components could be distributed in the unoccupied portion of the enclosure through the other accessible ports. These components can be added from the factory at the time of installation, or added later in the field as the need arises. The components, such as single or multi-drop cables could interact with the components mounted on the pivoting bodies, facilitating the speed and simplicity of network deployment.

The exemplary port entry device can further include a locking element (not shown) associated with each pivoting body to lock them in the open configuration after the support member has passed through the port of a telecommunication enclosure or terminal and the sealing body secured within said port.

The port entry, described above, provides a simple and user-friendly design that can facilitating installation of FTTH networks. The exemplary port entry devices allow the technician to install the optical fiber cable into the device at a location away from the telecommunication enclosure or terminal into which it will be installed. Alternatively the exemplary port entry devices can be factory installed and shipped to the job site where the technician plugs it into an appropriate port of a telecommunication enclosure or terminal. Additionally, the inlet device can require less space inside than telecommunications enclosure than conventional analogous accessories. Also, in some embodiments, the port entry device, when used as part of a pre-stubbed terminal, provides a connection point of the optical fibers within the terminal, as opposed to on the outer wall of the terminal. In this configuration, an additional degree of protection to the connection point between a multifiber feeder cable and the individual drop cables.

While the exemplary port entry device is described with respect to allowing cables to enter a telecommunication enclosure, the exemplary port entry device can be used for other applications where an elongated object needs to enter a sealed space, especially when the elongated object is connected to a component or device disposed within a sealed enclosure. The elongated object can be an optical fiber cable as described previously, an electrical line or cable or a tubular member configured to circulate liquids in and out of a sealed enclosure.

For example, in the telecommunications space, network providers are looking at bringing active electronics closer to the end user. However, the active electronics generate heat that may compromise performance over the long term which has limited where the active electronics can be placed in the network. In one exemplary use, a port entry device of the present invention may be used to provide cooling within a sealed enclosure. For example, optical fiber cables 50 in FIG. 5A can be replaced with coolant tubes and the optical component holder 570 can be replaced with a cooling device, such as a radiator or liquid cooled heat exchanger, that is connected to the coolant tubes. Liquid coolant can be pumped through the coolant tubes and the heat exchanger from outside of the enclosure to draw heat away from the active electronics disposed within the enclosure.

Alternatively, optical fiber cables 50 in FIG. 5A can be replaced with electric lines and the optical component holder 570 can be replaced by an electrical component or device such as a thermoelectric cooler manage the thermal footprint within the enclosure, or a media converter to convert communication signals between optical and electrical signals.

Various modifications including extending the use of the inlet device to applications with copper telecommunication cables or copper coax cables, equivalent processes, as well as numerous structures to which the present invention may be applicable will be readily apparent to those of skill in the art to which the present invention is directed upon review of the present specification.

We claim:

1. An advanced port entry device for a telecommunication enclosure having an environmentally protected interior space, the port entry device comprising:
a sealing body configured to engage with a port of the telecommunication enclosure, wherein the sealing body has an internal passageway extending from a first end of the sealing body to a second end of the sealing body, and
a tray member that holds slack fiber in at least a portion of tray member, the tray member extending from the first end of the sealing body that is configured to pass through the port so that it resides within the protected interior space of the telecommunication enclosure and an optical component holder disposed on a base of the tray member, wherein the optical component holder is configured to hold cable connection components.

2. The port entry device of claim 1, wherein the sealing body defined a first cross-sectional profile and the tray member defines a second cross-sectional profile, wherein the second cross-sectional profile is smaller than and can be inscribe in the first cross-sectional profile.

3. The port entry device of claim 1, wherein the sealing body has an elliptical cross section.

4. The port entry device of claim 1, wherein the tray member is integrally formed with the sealing body.

5. The port entry device of claim 1, wherein the tray member is separably connectable to the sealing body.

6. The port entry device of claim 1, wherein a free end of the tray member includes a secondary coupling structure to permit attachment to the telecommunication enclosure.

7. The port entry device of claim 1, wherein the cable connection components comprise at least one of an optical fiber splice, an optical fiber splitter, a WDM device and an optical fiber connector adapter.

8. The port entry device of claim 1, further comprising at least one of an optical fiber splice and an optical fiber connector adapter disposed on the support member.

9. An advanced port entry device for a telecommunication enclosure having an environmentally protected interior space, the port entry device comprising:
a sealing body configured to engage with a port of the telecommunication enclosure, wherein the sealing body has an internal passageway extending from a first end of the sealing body to a second end of the sealing body, and
a tray member that holds slack fiber in at least a portion of tray member, the tray member extending from the first end of the sealing body that is configured to pass through the port so that it resides within the protected interior space of the telecommunication enclosure wherein the tray member is a double sided tray member having a first functional side and a second functional side.

10. The port entry device of claim 9, wherein the first functional side is a fiber storage a fiber storage side and the second functional side is a fiber connection side.

11. The port entry device of claim 9, wherein the fiber connection side comprises an optical component holder disposed on a base of the tray member, wherein the optical component holder is configured to hold cable connection components.

12. The port entry device of claim 11, wherein the cable connection components comprise at least one of an optical fiber splice, an optical fiber splitter, a WDM device and an optical fiber connector adapter.

13. The port entry device of claim 9, wherein both the first functional side and the second functional sides are configured for fiber storage.

14. The port entry device of claim 9, wherein the double sided tray member includes at least one fiber pass through to allow optical fibers to pass from the first functional side to the second functional side.

15. The port entry device of claim 9, wherein the port inlet device is installed on the end of an optical fiber cable and at least one optical fiber or at least one optical fiber connector attached to the support member prior to insertion of the port entry device into the port of a telecommunication enclosure.

16. The port entry device of claim 9, wherein the port inlet device is factory installed on the end of an optical fiber cable.

17. The port entry device of claim 9, wherein the port inlet device is field installed on the end of an optical fiber cable prior to insertion into the port of the telecommunication enclosure.

18. The port entry device of claim 9, further comprising a fiber storage area for uncut optical fibers disposed on the support member.

19. The port entry device of claim 9, further comprising at least one pivoting body rotatably attached to the support member, wherein the pivot bodies are moveable from a closed configuration for insertion through the port and an open use configuration.

20. The port entry device of claim 1, wherein the pivoting body comprises an adapter mounting plate configured to hold a plurality of optical fiber connector adapters.
